(19) United States
(12) Patent Application Publication
(10) Pub. No.: US 2008/0020667 A1
(43) Pub. Date: Jan. 24, 2008

(54) Method of uniforming the thickness of a rib

(76) Inventors: Wei-Sheng Hsu, Taipei (TW); Chih-Che Kuo, Taipei (TW); Chi-Hung Hsiao, Taipei (TW); Ming-Chun Ho, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/489,497

(22) Filed: Jul. 20, 2006

(51) Int. Cl. H01J 9/24; H01J 9/00

(52) U.S. Cl. 445/24

(57) ABSTRACT

In a method of uniforming the thickness of a rib, steps are forming a plurality of blocked layers by many times of printing and stack, processing a first pre-bake of each blocked layer printed, processing a second pre-bake of in the final blocked layer, flattening the final blocked layer by the uniform plate, and solidify the blocked layers by a sintering process in the final to form a rip (insulation structure), thereby the thickness of rip being uniform.

### BACKGROUND OF THE INVENTION

1. Field of the Invention

This invention relates to a method of uniforming the thickness of a rib of a field emission display element and particularly to a technology of flattening the rib by preheating and lamination.

2. Description of Related Art

A field emission display (FED) uses an electric field to make a cathode electron emitter generate electrons; the electrons being excited and coated on an anode plate, fluorescence powder is made to generate rays of light, and the rays of light are displayed on the surface of anode plate. The FED comprises a cathode plate, a anode plate corresponding to the cathode plate, and a rib set between the cathode plate and the anode plate. The rib provides a space for a vacuum region between the cathode plate and the anode plate so that a plurality of units are formed in the region, and thus the rib serves as a supporting structure between the cathode plate and the anode plate. The ribs may be created in a photolithography process or a halftone printing process, in which the cost of halftone printing is lower and it is easier to implement the halftone printing so that most owners prefer the halftone printing; the ribs are created by means of inclusive screen printing in the photolithography process.

Refer to FIGS. 1A through 1E that illustrate a conventional method of forming a rib in a printing process. In the figures, it is apparent that the conventional printing method of forming the rib comprises the steps of providing an anode substrate 1a, setting a halftone screen 2a at the top of a substrate 2a and forming a clearance from the anode substrate 1a, and pouring glass paste 3a down to a predetermined site of the halftone screen 2a. The anode substrate 1a is pressed close to the bottom of the halftone screen 2a, as shown in FIG. 1A. A floor bar 4a is used to scrape the glass paste 3a in the direction of behavior A so that the glass paste 3a may cover a latex pattern on the halftone screen 2a, as shown in FIG. 1B. Then, a scraper 5a is pressed down and runs in the direction B of behavior that is reverse to the predetermined direction B of behavior so as to distribute the glass paste 3a according to the size of latex pattern that is further printed on the anode substrate 1a, thereby a blocked layer 31a as shown in FIG. 1C being formed, in which the halftone screen 2a is provided with a net frame 21a and a sheet of net cloth 22a. Thus, by means of the scraper 5a that presses down the net cloth 22a of the halftone screen 2a, the glass paste 3a is coated on the anode substrate 1a so that the blocked layer 31a is formed, as shown in FIGS. 1C and 1D, and further by means of the scraper 5a that scrapes and press down the net cloth 22a repeatedly, a rib 6a with several blocked layers 31a is formed, as shown in FIG. 1E.

However, the sets of difference of the uniformity of thickness of the conventional rib in the printing process are in the following: (1) the error margin of 5 μm of thickness of the rib 6a; (2) when the scraper 5a scrapes in the printing process, the ribs 6a at two sides are thicker than the rib 6a in the center by 10 μm in that the conventional printing mechanism comprises the halftone screen 2a and the scraper 5a, in which the halftone screen 2a is formed with the net cloth 22a and the net frame 21a giving a bearing power to make the net cloth 22a keep a tensile force to resist the pressure applied by the scraper 5a and to make the net cloth 22a neat, in order to make the coat on the net cloth 22a adhere to the anode substrate 1a through the totem mesh of the net cloth 22a by means of the scraper 5a applied with force, when the scraper 5a is pressed down, only parts of regions of the net cloth 22a are contacted and printed in the anode substrate 1a, while the rests are limited by the supporting capability of net frame 21a so as to upward come off the surface of anode substrate 1a; (3) the printing coat is high viscous, so residual stress is still kept on the totem after the printing process, and thus irregular lugs are easily caused on the surface of totem; and (4) after the scraper 5a rubs against the net cloth 22a, because the scraper 5a is of rubber and the net cloth 22a is of stainless steel, the scraper 5a is easily worn down when scraping in the printing process and thus the distributed thickness of rib 6a formed in the printing process is unbalanced, and further the error margin of thickness of the rib 6a piling up in the printing process becomes higher.

For this reason, in consideration of improvability of the defects described above, this inventor especially concentrates on studies and operate in coordination with academic theories in addition to the experience in this field for many years, finally providing this invention for a design reasonable and effective improvement of the defects mentioned above.

### SUMMARY OF THE INVENTION

It is an object of this invention to provide a mechanism for processing a rib in the printing process, a method of flattening the surface of rib for the uniform thickness of rib, and particularly a method of controlling the thickness of each rib of a large-sized panel for the uniform thickness of rib.

In order to achieve the objective mentioned above, this invention provides a method of making the thickness of a rib uniform, comprising the steps of: (a) forming a blocked layer on a substrate by means of a printing process; (b) plasticizing the surface of blocked layer through a first pre-bake; (c) piling another blocked layer on the blocked layer in the printing process; (d) plasticizing the surface of blocked layer through the first pre-bake; (e) repeating steps (c) and (d) to pile up a plurality of blocked layers repeatedly; (f) plasticizing the surface of the last blocked layer through a second pre-bake; (g) using a uniform panel to exert pressure on the surface of the last blocked layer so as to make flat the surface (thickness) of the last blocked layer; (h) solidifying the blocked layers by a sinter process in the final to form a rip; at the steps (a) through (h), the thickness of rib may be uniform.

Besides, in this invention, limit components and adjusting components are respectively provided at four corners of the uniform panel, in which each of the limit components is provided for a reference height corresponding to the thickness of rib and each of the adjusting components is connected to each of the limit components to adjust or set up the reference height and further give buffering pressure that upward resists the pressure, thereby preventing the rib from collapsing and distortion due to higher pressure in the process of panel printing.

In order to further understand the technical means and effects adopted to achieve the objectives of this invention, please refer to the detailed description and accompanied drawings according to this invention. It is believed that the objectives, features, and points of this invention will be apparent from the description; however, the accompanied drawings are provided for reference and illustration only and not intended to limit the terms or scope of this invention.

### BRIEF DESCRIPTION OF THE DRAWINGS

FIGS. 1A through 1E are schematic views illustrating a conventional method of halftone printing for a rib;

FIG. 2 is a block diagram of steps of making uniform the thickness of a rib according to this invention; and

FIGS. 3A through 3D are schematic structural views illustrating the method of making uniform the thickness of rib according to this invention.

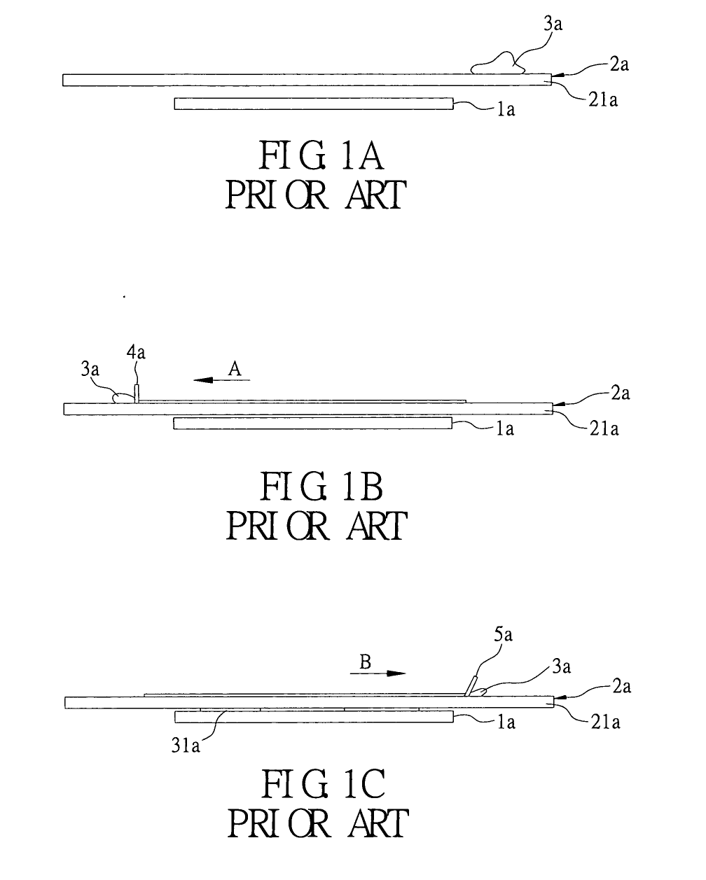

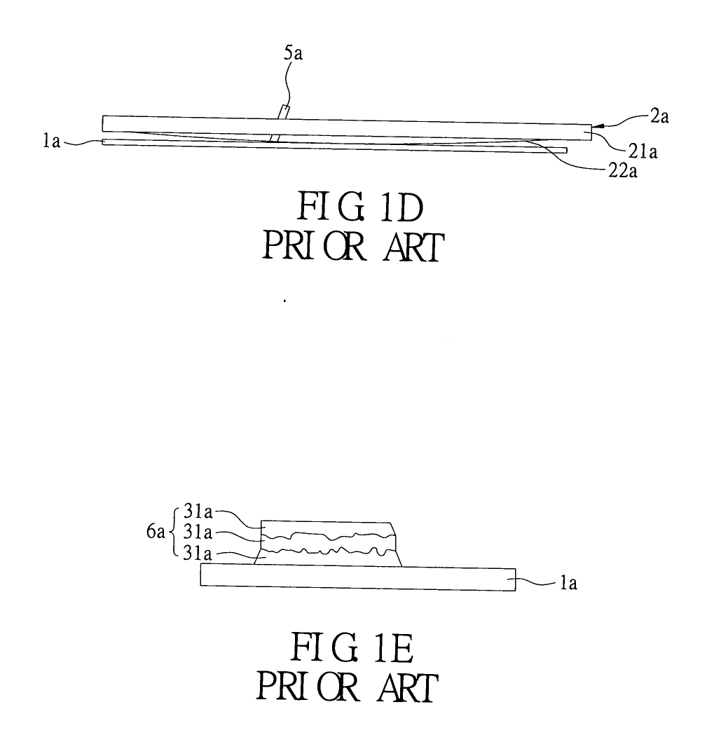

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

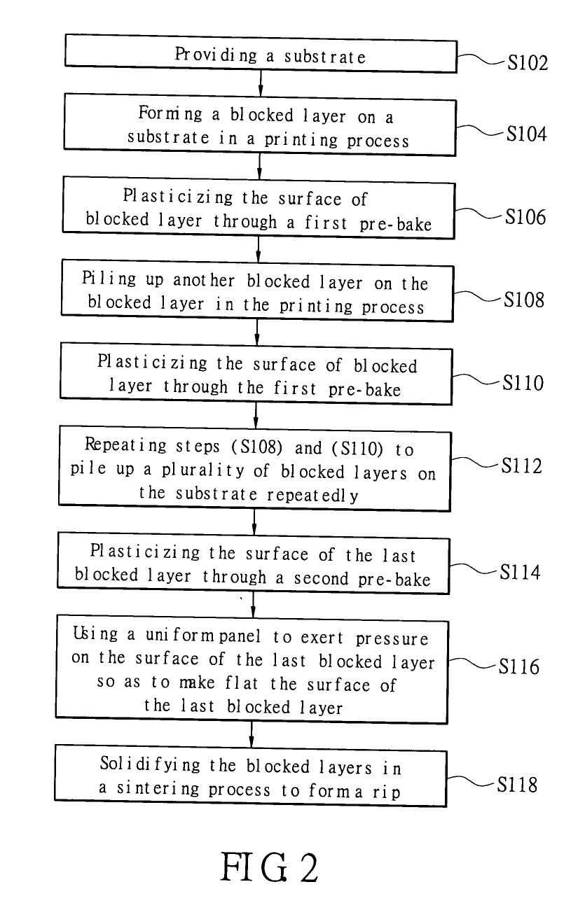

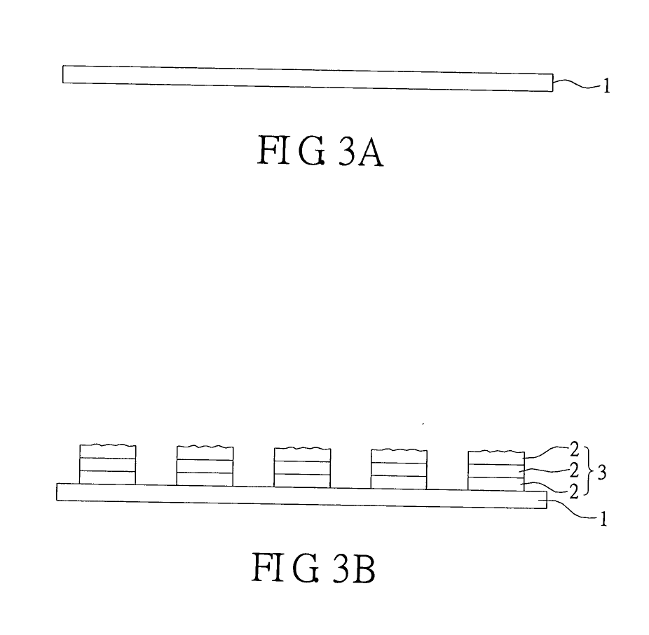

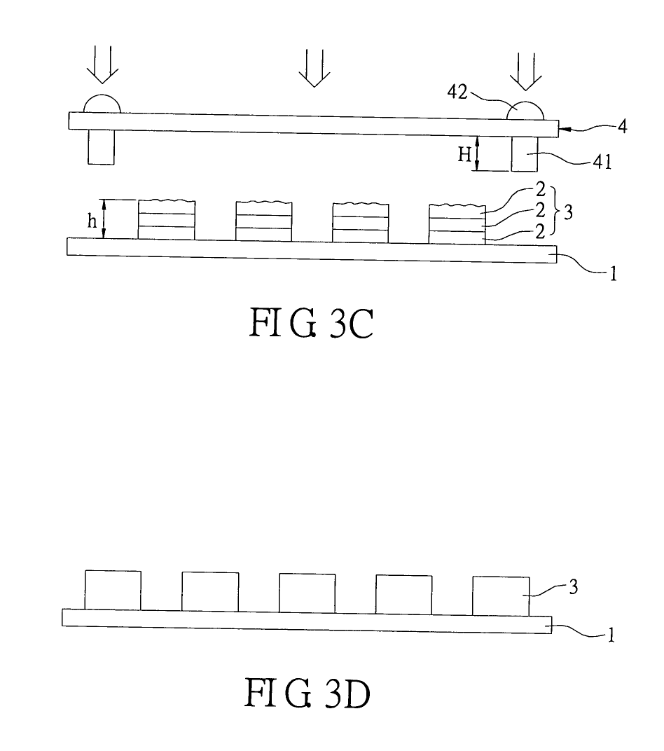

Refer to FIG. 2 and FIGS. 3A through 3D as a structural flow chart illustrating a method of making uniform the thickness of rib according to this invention. In FIG. 2, the steps are (1) providing a substrate 1 (S102); (2) forming a blocked layer 2 on a substrate 1 in a printing process (S104); (3) plasticizing the surface of blocked layer 2 through a first pre-bake (S106); (4) piling up another blocked layer 2 on the blocked layer 2 in the printing process (S108); (5) plasticizing the surface of blocked layer 2 through the first pre-bake (S110); (6) repeating steps (S108) and (S110) to pile up a plurality of blocked layers 2 on the substrate 2 repeatedly (S112); (7) plasticizing the surface of the last blocked layer 2 through a second pre-bake (S114); (8) using a uniform panel 4 to exert pressure on the surface of the last blocked layer 2 so as to make flat the surface of the last blocked layer 2 (S116); (9) finally solidifying the blocked layers 2 in a sintering process to form a rip 3 (S118). Through the steps mentioned above, the thickness of rib structure 3 may be uniform.

The first pre-bake is executed at the temperature of 100° C. lasting for 10 minutes to remove part of solution in the coating for printing the blocked layer 2 and then temporarily enhance the plasticity of the blocked layer 2 and prop up follow-up piled blocked layer 2, which unlikely makes the blocked layer 2 collapse or broken. The second pre-bake is executed at the temperature of 100□ lasting for 2 minutes to remove the solvent on the surface of the last blocked layer for fear of the surface of the last blocked layer that is stained with the surface of panel and for the plasticity of the last blocked layer 2. The sintering is executed at the temperature of 400° C. to solidify the rib 3 for achievement of the expected strength. The pressure applied by the panel 4 to the last blocked layer 2 is 0.75 Kg/cm², and the distributed thickness of the surface of last blocked layer 2 after flattened is 69.7 [symbol] Ó0.3 μm, in which the error margin of distributed thickness is below 0.5 μm. The panel 4 is made of a steel material and is unlikely deflected and distorted when receiving the pressure, and the thickness of formed rib 3 may be 70.5±5.0 μm.

In this invention, a material used in the blocked layer 2 is glass paste of which the viscosity is 274000c.p. For implementation of this invention, after the last printing is executed, the panel 4 is used to give pressure for achievement of the flattened rib 3. The uneven surface and the error margin that are caused in the previous printing processes are covered in the final printing and piling.

By the way, in this invention, limit components 41 and adjusting components 42 are further provided at four corners of the uniform panel 4, respectively. Each of the limit components 41 is provided for a reference height H corresponding to the thickness h of rib 3, and the length of reference height H is corresponding to the thickness h of rib 3 (In this embodiment, the determined reference height H is 70 μm to be corresponding to the thickness h of rib 3). The adjusting component 42 is connected to the limit component 41 to adjust or set up the reference height H and may be a flexible knob that flexibly revolves to adjust the reference height H corresponding to the height h of rib 3 (elongate or shorten the reference height H to be corresponding to the height h of rib 3); after adjustment of the reference height H, the panel 4 is given balanced buffering pressure to upward resist the pressure in the printing process, thereby preventing the rib 3 from being broken due to excessive pressure applied by the panel 4.

From the description made above, the uniform panel 4 according to this invention is used to apply pressure onto the last blocked layer 2 so that the formed rib 3 is provided with the following advantages:
1. In the manner of the press and printing of panel, defects, such as the uneven surface of rib and unevenly distributed thickness, caused by the conventional screen printing are improved.
2. The effect of uniformity of the electric field of field emission is greatly promoted so that the uniformity of emission definition is improved.
3. Before the panel applies pressure, the second pre-bake is executed so that the formed coating for the blocked layer is plasticized and unlikely stained with the panel.
4. The first pre-bake is executed for the blocked layer each time after pressed and printed so as to remove part of solution on the blocked layer and then temporarily enhance the blocked layer and prop up follow-up piled blocked layer, which prevents the follow-up piled blocked layer from collapsing due to the weak strength of bottom blocked layer.

However, in the description mentioned above, only the preferred embodiments according to this invention are provided without limit to claims of this invention; all those skilled in the art without exception should include the equivalent changes and modifications as falling within the true scope and spirit of the present invention.

What is claimed is:

1. A method of uniforming the thickness of a rib, comprising the steps of:
(a) forming a blocked layer on a substrate by means of a printing process;
(b) plasticizing one surface of the blocked layer through a first pre-bake;
(c) piling another blocked layer on the blocked layer in the printing process;
(d) plasticizing one surface of the other blocked layer through the first pre-bake;
(e) repeating steps (c) and (d) to pile up a plurality of blocked layers repeatedly;
(f) plasticizing one surface of the last blocked layer through a second pre-bake;
(g) using a uniform panel to exert pressure on the surface of the last blocked layer so as to make flat the surface of the last blocked layer; and
(h) solidifying the blocked layers by a sintering process in the final to form a rip;
whereby, the thickness of rib may be uniform through the steps of (a) to (h).

2. The method of uniforming the thickness of rib according to claim 1, further comprises four limit components are respectively provided at four corners of the panel and each of the limit components is provided for a reference height corresponding to the thickness of rib.

3. The method of uniforming the thickness of rib according to claim 2, further comprises four adjusting components are respectively provided at four corners of the uniform panel and each of the adjusting components is connected to each of the limit components to adjust or set up the reference height.

4. The method of uniforming the thickness of rib according to claim 3, wherein the adjusting component is a flexible knob.

5. The method of uniforming the thickness of rib according to claim 2, wherein the reference height is set to upward resist the balanced buffering pressure, thereby preventing the rib from being broken due to excessive pressure applied by the panel.

6. The method of uniforming the thickness of rib according to claim 1, wherein the first pre-bake is executed at the temperature of 100° C. lasting for 10 minutes.

7. The method of uniforming the thickness of rib according to claim 1, wherein the second pre-bake is executed at the temperature of 100° C. lasting for 2 minutes.

8. The method of uniforming the thickness of rib according to claim 1, wherein the second pre-bake is executed to remove the solvent on the surface of the last blocked layer for fear of the surface of the last blocked layer that is stained with the surface of panel and for the plasticity of the last blocked layer.

9. The method of uniforming the thickness of rib according to claim 1, wherein the sintering is executed at the temperature of 400° C.

10. The method of uniforming the thickness of rib according to claim 2, wherein a length of the reference height is 70 μm.

11. The method of uniforming the thickness of rib according to claim 1, wherein the pressure applied by the panel onto the last blocked layer is 0.75 Kg/cm².

12. The method of uniforming the thickness of rib according to claim 1, wherein the error margin of distributed thickness of the surface of last blocked layer after flattened is below 0.5 μm.

13. The method of uniforming the thickness of rib according to claim 1, wherein a material used in the blocked layer is glass paste.

14. The method of uniforming the thickness of rib according to claim 13, wherein the viscosity of the glass paste is 274000c.p.

15. The method of uniforming the thickness of rib according to claim 1, wherein the panel is made of a steel material and is unlikely deflected and distorted when receiving the pressure.
